(19) United States
(12) Patent Application Publication
(10) Pub. No.: US 2009/0174206 A1
(43) Pub. Date: Jul. 9, 2009

(54) MULTI-POSITIONAL LID FOR A VEHICLE CONSOLE

(76) Inventors: Daniel Roger Vander Sluis, Plymouth, MI (US); Ian Lee Foslien, Canton, MI (US); Dale Owen Cramer, Royal Oak, MI (US)

Correspondence Address: FRASER CLEMENS MARTIN & MILLER LLC, 28366 KENSINGTON LANE, PERRYSBURG, OH, 43551, US

(21) Appl. No.: 11/969,312

(22) Filed: Jan. 4, 2008

(51) Int. Cl. B60R 7/00

(52) U.S. Cl. 296/24.34

(57) ABSTRACT

A console having a movable lid capable of pivoting about dual axes is disclosed, the lid including at least one hinge to facilitate rotation about a first axis and a rotating element to facilitate rotation about a second axis, wherein the at least one hinge and the rotating element are adapted to permit storage of articles and electrical connectivity or electronic interface of articles disposed in a compartment of the lid.

### FIELD OF THE INVENTION

The invention relates to a console for a vehicle, and more particularly to a console having a movable lid capable of pivoting about a first axis and a second axis, wherein the first axis is substantially perpendicular in respect of the second axis.

### BACKGROUND OF THE INVENTION

It is well known to provide a console between driver and passenger seats in a vehicle. Typically, the console includes a lid which functions as an armrest for the passengers, a closure for a storage compartment formed in the console, and a beverage holder. Presently, there are lids for consoles which permit access to the storage compartment from the sides, top, or front of the console.

One such lid is disclosed in U.S. Pat. No. 6,644,526 entitled MOTOR VEHICLE CENTRAL CONSOLE, hereby incorporated herein by reference in its entirety. The lid is removably coupled to an enclosure disposed in a central console of a vehicle. The lid can pivot equally about at least two axes of rotation, which are substantially parallel in respect to each other. Accordingly, the lid permits access to the enclosure from the sides and the top of the enclosure. However, the lid does not permit an underside of the lid to be easily utilized by the passengers.

Various other lids attempt to accommodate the storage needs of the passengers by providing features to the underside of the lid. Traditionally, such features include a pocket, an elastic cord, a net, and other materials used to capture articles therein, for example.

In U.S. Pat. No. 6,000,572 entitled CONSOLE BOX hereby incorporated herein by reference in its entirety, a console box is disclosed. The console box utilizes space inside the outer lid by having an inner lid disposed therein. The inner lid is adapted to receive small articles therein and pivot in accordance with the movement of the outer lid.

Although the aforementioned structures operate effectively, the structures are complex, involve higher manufacturing costs, and provide limited accessibility to storage compartments.

Accordingly, it would be desirable to produce a console having a movable lid capable of pivoting about dual axes, wherein a storage and an accessibility to the storage are maximized and a cost and complexity thereof are minimized.

### SUMMARY OF THE INVENTION

In concordance and agreement with the present invention, a console having a movable lid capable of pivoting about dual axes, wherein a storage and an accessibility to the storage are maximized and a cost and complexity thereof are minimized, has surprisingly been discovered.

In one embodiment, the console comprises a main body; and a lid mounted on the main body, wherein the lid is pivotable relative to the main body about a first axis and about a second axis, wherein the first axis is disposed at an angle in respect of the second axis.

In another embodiment, the console comprises a main body; and a lid disposed on the main body, the lid including a first segment and a second segment having a compartment formed therein, wherein the first segment is mounted to the main body by at least one hinge and pivotable relative to the main body about a first axis thereof, and the second segment is coupled to the first segment by a rotating element and pivotable relative to the main body about a second axis thereof, wherein the first axis is disposed at an angle in respect of the second axis.

In another embodiment, the console comprises a main body; and a lid disposed on the main body, the lid including a compartment formed therein, wherein the lid is mounted to the main body by a hinge coupled to a rotating element and pivotable relative to the main body about a first axis and about a second axis, and wherein the first axis is disposed at an angle in respect of the second axis.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a fragmentary cross-sectional view of a console according to an embodiment of the invention;

FIG. 2 is an enlarged fragmentary sectional view of a hinge area of the console illustrated in FIG. 1, within circle 2;

FIG. 3 is a fragmentary perspective view of the console illustrated in FIG. 1, wherein a second segment of a lid of the console is in a rotated position;

FIG. 4 is a fragmentary perspective view of a console according to another embodiment of the invention, wherein a rotating element is disposed in a lid of the console; and

FIG. 5 is a fragmentary perspective view of the console illustrated in FIG. 4, wherein the rotating element is disposed in a main body of the console.

### DETAILED DESCRIPTION OF THE PREFERRED EMBODIMENTS OF THE INVENTION

The following detailed description and appended drawings describe and illustrate exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

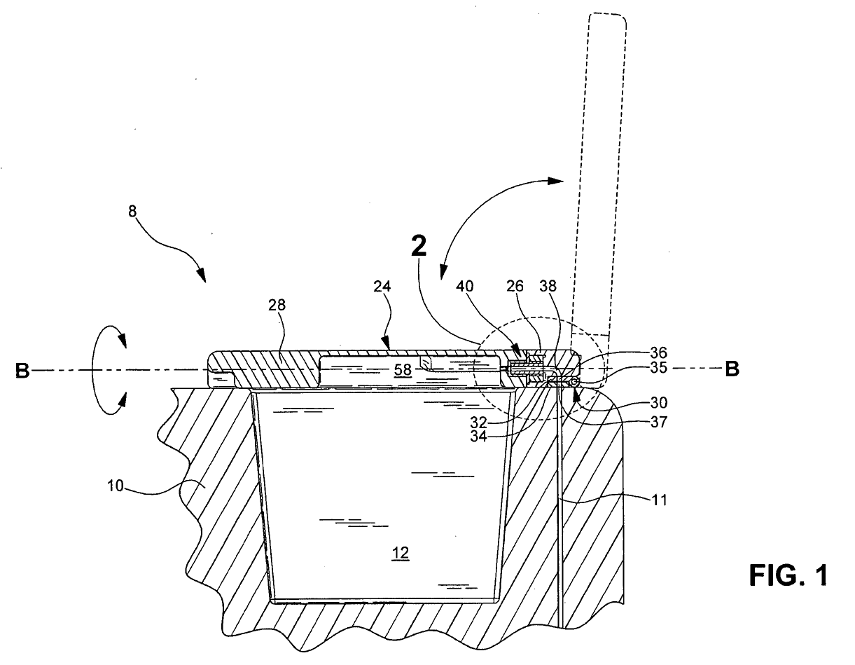

FIG. 1 shows a console 8 according to an embodiment of the invention. The console 8 shown is a center console for a front area of a passenger compartment of a vehicle, although it is understood that the console can be other console types if desired such as a center console for a rear area of the passenger compartment of the vehicle. The console 8 includes a main body 10 having a passage 11 formed therein. The passage 11 is adapted to receive wire (not shown) therethrough. The wire is in electrical communication with at least one input/output device (not shown) such as a power source, speakers of the vehicle, a digital versatile disc player, and the like, for example.

A lid 24 is provided to extend from the main body 10 of the console 8. In the embodiment shown, the lid 24 is adapted to substantially cover a cavity 12 formed in the main body 10. The lid 24 includes a first segment 26 and a second segment 28. Although each of the first segment 26 and the second segment 28 shown has a generally rectangular shape, it is understood that the first segment 26 and the second segment 28 can have other shapes as desired.

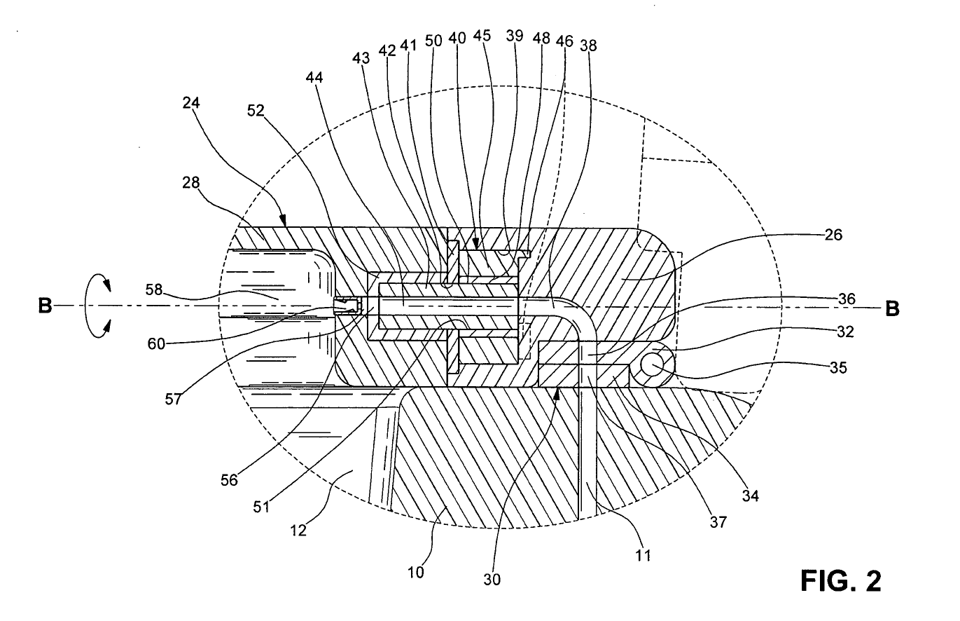

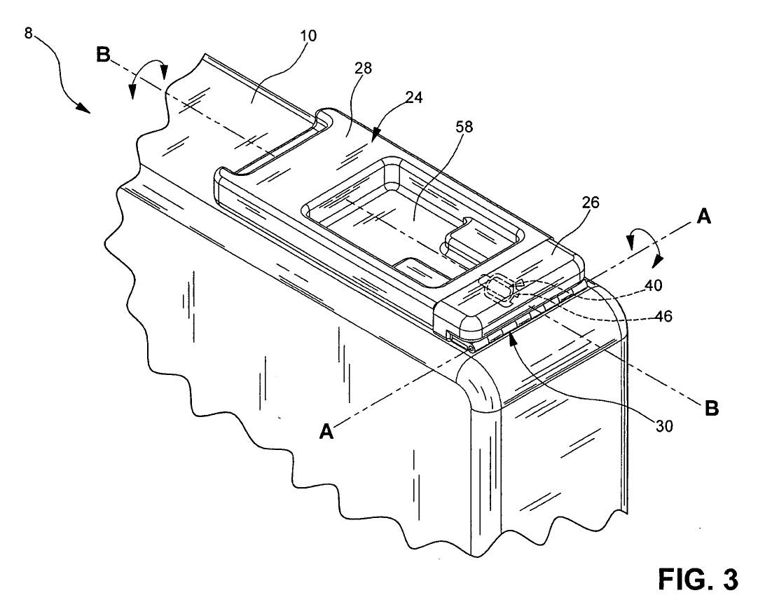

The first segment 26 of the lid 24 is mounted to the main body 10 of the console 8 by at least one hinge 30. The at least one hinge 30 is adapted to facilitate a rotation of the lid 24 about a first axis A-A illustrated in FIG. 3. The at least one hinge 30 permits the lid 24 to laterally pivot from a first position, as shown in FIGS. 1, 2, and 3, to a second position, as indicated by the dashed lines in FIGS. 1 and 2. It is understood that the lid 24 can pivot to a position intermediate the first position and the second position as desired. In the embodiment shown, the first position is a substantially closed position and the second position is a substantially open position.

As more clearly illustrated in FIG. 2, the at least one hinge 30 includes a pair of plates 32, 34 coupled together by a pin 35. The plate 32 includes at least one aperture 36 formed therein and is mounted to the first segment 26 of the lid 24 by any conventional means such as fasteners, glue, and the like, for example. The aperture 36 is adapted to receive the wire therethrough. The plate 34 includes at least one aperture 37 formed therein and is mounted to the main body 10 of the console 8 by any conventional means such as fasteners, glue, and the like, for example. The aperture 37 is adapted to receive the wire therethrough and is substantially aligned with the passage 11 and the aperture 36. It is understood that the at least one hinge 30 can be any conventional hinge type such as a butt hinge, a barrel hinge, a piano hinge, a butterfly hinge, a flush hinge, and a concealed hinge, for example.

The first segment 26 includes a passage 38 and a cavity 39 formed therein. The passage 38, adapted to receive the wire therethrough, is substantially aligned with the apertures 36, 37 of the at least one hinge 30. A rotating element 40 is disposed in the cavity 39 of the first segment 26 and secured therein by a plate 41. The plate 41 includes an aperture 42 formed therein. The plate 41 is affixed to the first segment 26 by any conventional means such as fasteners, glue, and the like, for example.

The rotating element 40 includes a hollow shaft 43 having a passage 44 formed therethrough. The passage 44, adapted to receive the wire therethrough, is substantially aligned with the passage 38 formed in the first segment 26. In the embodiment shown, the shaft 43 has a generally cylindrical shape, although it is understood that the shaft 43 can have other shapes as desired. One end of the shaft 43 is disposed in a hollow cylindrical housing 45. Another end of the shaft 43 extends through the aperture 42 of the plate 41. The housing 45 includes a plurality of protuberances 46 extending axially outwardly therefrom. The protuberances 46 are adapted to engage the first segment 26 to militate against a rotation of the housing 45. It is understood that the housing 45 can be formed integrally with the first segment 26 of the lid 24 if desired. A bearing element 48 is disposed in the housing 45 to surround the shaft 43 and permit a rotation thereof. The bearing element 48 is disposed on an outer surface 50 of the shaft 43. The shaft 43 shown is secured in the housing 45 by a frictional engagement of the outer surface 50 of the shaft 43 with an inner surface 51 of the bearing element 48. It is understood that the shaft 43 can be secured in the housing 45 by any conventional means such as a cross pin having an aperture formed therein, for example. It is further understood that the shaft 43, the housing 45, and the bearing element 48 can be produced from any conventional material such as a metal and a polyamide, for example.

The first segment 26 of the lid 24 is coupled to the second segment 28 of the lid 24 by the shaft 43 of the rotating element 40. The shaft 43 is adapted to support the second segment 28 of the lid 24 and facilitate a rotation thereof about a second axis B-B shown in FIGS. 1, 2, and 3. As illustrated, the second axis B-B is a longitudinal axis of the second segment 28. It is understood that an angle of rotation of the second segment 28 ranges from 0 degrees to 360 degrees. The rotating element 40 permits the second segment 28 to pivot from an initial position, as shown in FIGS. 1 and 2, to a rotated position, as shown in FIG. 3. It is understood that the second segment 28 can be permitted to pivot to a position intermediate the initial position and the rotated position as desired.

The second segment 28 of the lid 24 includes a receiving element 52 disposed therein. It is understood that the receiving element 52 may be formed integrally with the second segment 28 of the lid 24 if desired. The receiving element 52 is adapted to receive the shaft 43 of the rotating element 40 therein. The shaft 43 is secured in the receiving element 52 by any conventional means such as fasteners, glue, frictional engagement, and the like, for example. The receiving element 52 includes at least one aperture 56 formed therein. The aperture 56, adapted to receive the wire therethrough, is substantially aligned with the passage 44 of the shaft 43.

The second segment 28 also includes a passage 57 and a compartment 58 formed therein. The passage 57, adapted to receive the wire therethrough, is substantially aligned with the aperture 56 of the receiving element 52 and the passage 44 of the shaft 43. In the embodiment shown, the compartment 58 is formed in an underside of the lid 24, although it is understood that the compartment 58 can be formed elsewhere in the lid 24 as desired. The compartment 58 is adapted to receive articles for storage or electronic interface such as consumer electronics, data storage devices, display monitors, and the like, for example. At least one input/output connector 60 is disposed in the passage 57 of the second segment 28 adjacent the compartment 58. The at least one input/output connector 60 is in electrical communication with the input/output device through the wire.

It is understood that additional segments may be coupled to the first segment 26 and the second segment 28 using similar hinges and rotating elements as described above.

In operation, the lid 24 is lifted upwardly by one of a driver-side, passenger-side, or rear seat occupant of the vehicle. Accordingly, the lid 24 is caused to pivot about the first axis A-A from the first position to the second position or intermediate the first position and the second position. Once the lid 24 is in the second position or intermediate the first position and the second position, the second segment 28 of the lid 24 can be caused by the occupant to pivot about the second axis B-B, providing access to the compartment 58 formed in the second segment 28 of the lid 24. The articles for storage or electronic interface can then be disposed in the compartment 58 and plugged into the input/output connector 60 if desired or retrieved therefrom.

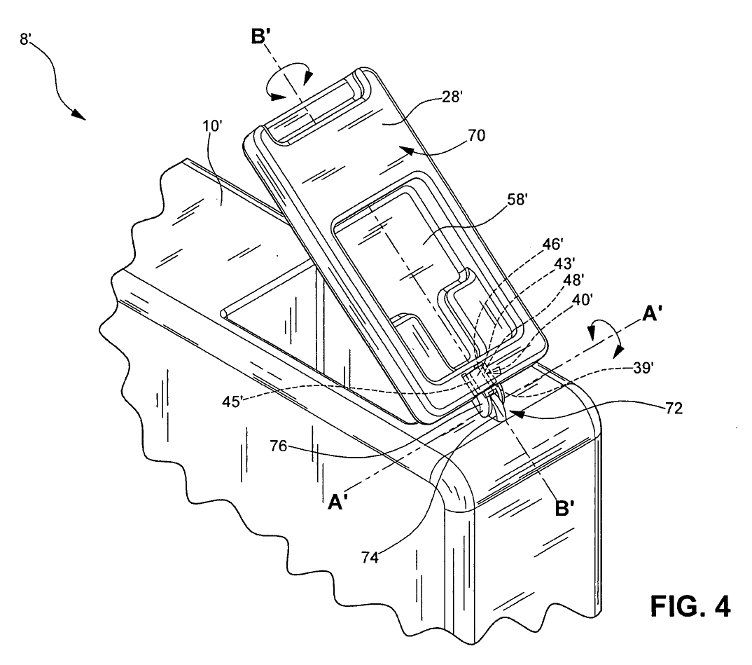

FIG. 4 shows another embodiment of the invention which includes a console similar to that shown in FIGS. 1 thru 3. Reference numerals for similar structure in respect of the description of FIGS. 1 thru 3 are repeated in FIG. 4 with a prime (′) symbol.

FIG. 4 shows a console 8′. The console 8′ includes a main body 10′ having a passage (not shown) formed therein. The passage is adapted to receive wire (not shown) therethrough. The wire is in electrical communication with at least one input/output device (not shown) such as a power source, speakers of the vehicle, a digital versatile disc player, and the like, for example.

A lid 70 is provided to extend from the main body 10′ of the console 8′. In the embodiment shown, the lid 70 is adapted to substantially cover a cavity 12′ formed in the main body 10′. Although the lid 70 in the embodiment shown has a generally rectangular shape, it is understood that the lid 70 can have other shapes as desired. The lid 70 includes a cavity 39′ formed therein. A rotating element 40′ is disposed in the cavity 39′ and secured therein by a plate (not shown) having an aperture formed therein. The plate is affixed to the lid 70 by any conventional means such as fasteners, glue, and the like, for example. The rotating element 40′ permits the lid 70 to pivot from an initial position to a rotated position, as shown. It is understood that the lid 70 can pivot to a position intermediate the initial position and the rotated position as desired.

The rotating element 40′ includes a hollow shaft 43′ having a passage formed therethrough. The passage is adapted to receive the wire therethrough. In the embodiment shown, the shaft 43′ has a generally cylindrical shape, although it is understood that the shaft 43′ can have other shapes as desired. One end of the shaft 43′ is disposed in a hollow cylindrical housing 45′. Another end of the shaft 43′ extends through the aperture of the plate. The housing 45′ includes a plurality of protuberances 46′ extending axially outwardly therefrom. The protuberances 46′ are adapted to engage the lid 70 to militate against a rotation of the housing 45′. It is understood that the housing 45′ can be formed integrally with the lid 70 if desired. A bearing element 48′ is disposed in the housing 45′ to surround the shaft 43′ and permit a rotation thereof. The bearing element 48′ is disposed on an outer surface of the shaft 43′. The shaft 43′ shown is secured in the housing 45′ by a frictional engagement of the outer surface of the shaft 43′ with an inner surface of the bearing element 48′. It is understood that the shaft 43′ can be secured in the housing 45′ by any conventional means such as a cross pin having an aperture formed therein, for example.

The shaft 43′ is adapted to support the lid 70 and facilitate a rotation thereof about a second axis B′-B′. As illustrated, the second axis B′-B′ is a longitudinal axis of the lid 70. It is understood that an angle of rotation of the lid 70 ranges from 0 degrees to 360 degrees. It is further understood that the shaft 43′, the housing 45′, and the bearing element 48′ can be produced from any conventional material such as a metal and a polyamide, for example.

The lid 70 illustrated is mounted to the main body 10′ of the console 8′ by a hinge 72 coupled to the rotating element 40′. The hinge 72 is adapted to facilitate a rotation of the lid 70 about a first axis A′-A′. The hinge 72 permits the lid 70 to laterally pivot from a first position to a second position. In the embodiment shown, the first position is a substantially closed position and the second position is a substantially open position. As shown, the lid 72 can pivot to a position intermediate the first position and the second position.

In the embodiment shown, the hinge 72 includes a base 74 coupled together with a substantially U-shaped member 76. The base 74 includes a passage (not shown) formed therethrough and is mounted to the main body 10′ of the console 8′ by any conventional means such as fasteners, glue, and the like, for example. It is understood that the base 74 can be formed integrally with the main body 10′ of the console 8′ if desired. The member 76 having a passage (not shown) formed therethrough is mounted to the shaft 43′ of the rotating element 40′ by any conventional means such as fasteners, glue, and the like, for example. It is understood that the member 76 can be formed integrally with the rotating element 40′ if desired. The passages, adapted to receive the wire therethrough, are substantially aligned with the passage formed in the main body 10′ of the console 8′, each other, and the passage formed in the shaft 43′ of the rotating element 40′. It is understood that the hinge 72 can be any conventional hinge type such as a butt hinge, a barrel hinge, a piano hinge, a butterfly hinge, a flush hinge, and a concealed hinge, for example.

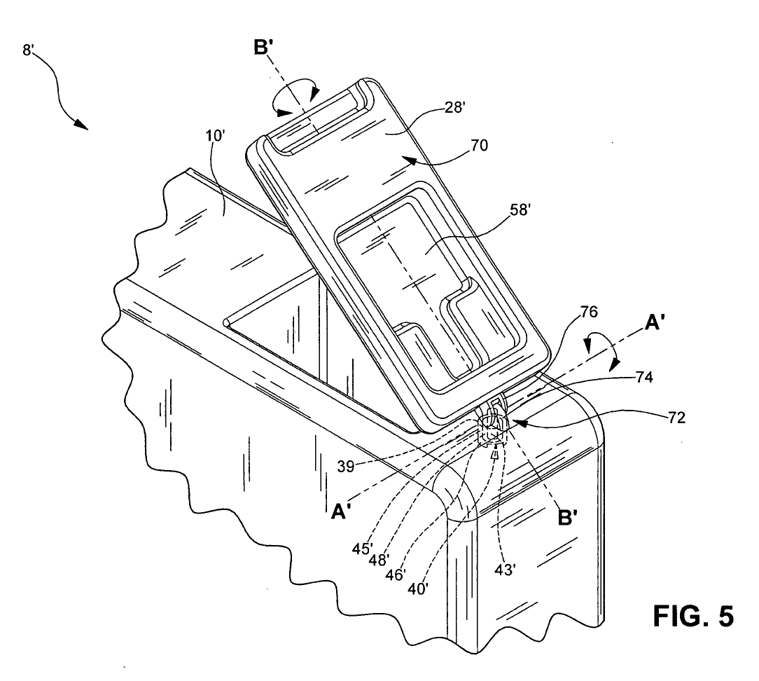

As illustrated in FIG. 5, the rotating element 40′ can be disposed in the main body 10′ of the console 8′ and the hinge 72 can be mounted to the lid 70. It is understood that the hinge 72 can be integrally formed with the rotating element 40′, as shown, or mounted to the shaft 43′ of the rotating element 40′ by any conventional means such as fasteners, glue, and the like, for example. The housing 45′ of the rotating element 40′ can be formed integrally with the body 10′ of the console 8′ if desired. It is understood that the hinge 72 can be integrally formed with the lid 70 or mounted to the lid 70 by any conventional means such as fasteners, glue, and the like, for example.

The lid 70 also includes a passage (not shown) and a compartment 58′ formed therein. The passage, adapted to receive the wire therethrough, is substantially aligned with the passage of the shaft 43′ and the passages of the hinge 72. In the embodiment shown, the compartment 58′ is formed in an underside of the lid 70, although it is understood that the compartment 58′ can be formed elsewhere in the lid 70 as desired. The compartment 58′ is adapted to receive articles for storage or electronic interface such as consumer electronics, data storage devices, display monitors, and the like, for example. At least one input/output connector (not shown) is disposed in the passage of the lid 70 adjacent the compartment 58′. The at least one input/output connector is in electrical communication with the input/output device through the wire.

In operation, the lid 70 is lifted upwardly by one of a driver-side, passenger-side, or rear seat occupant of the vehicle. Accordingly, the lid 70 is caused to pivot about the first axis A′-A′ from the first position to the second position or intermediate the first position and the second position. Once the lid 70 is in the second position or intermediate the first position and the second position, the lid 70 can be caused by the occupant to pivot about the second axis B′-B′, providing access to the compartment 58′ formed in the lid 70. The articles for storage or electronic interface can then be disposed in the compartment 58′ and plugged into the input/output connector if desired or retrieved therefrom.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A console comprising:
a main body; and
a lid mounted on the main body, wherein the lid is pivotable relative to the main body about a first axis and about a second axis, wherein the first axis is disposed at an angle in respect of the second axis.

2. The console according to claim 1, wherein the lid is adapted to receive a wire therein in electrical communication with an input/output device.

3. The console according to claim 1, wherein the lid includes a compartment formed therein.

4. The console according to claim 1, wherein the lid includes a first segment and a second segment.

5. The console according to claim 1, wherein the lid is mounted to the main body by at least one hinge.

6. The console according to claim 1, wherein the second axis is a longitudinal axis of the lid.

7. The console according to claim 1, wherein the first axis is substantially perpendicular to the second axis.

8. A console comprising:
a main body; and
a lid disposed on the main body, the lid including a first segment and a second segment having a compartment formed therein, wherein the first segment is mounted to the main body by at least one hinge and pivotable relative to the main body about a first axis thereof, and the second segment is coupled to the first segment by a rotating element and pivotable relative to the main body about a second axis thereof, wherein the first axis is disposed at an angle in respect of the second axis.

9. The console according to claim 8, wherein the first segment, the second segment, and the rotating element are adapted to receive a wire therein in electrical communication with an input/output device.

10. The console according to claim 8, wherein the compartment is adapted to receive articles for at least one of storage and electronic interface.

11. The console according to claim 8, wherein the compartment is in electrical communication with an input/output device.

12. The console according to claim 8, wherein the rotating element includes a housing, a hollow shaft disposed in the housing, and a bearing element disposed between the housing and the hollow shaft to facilitate a rotation of the shaft therein.

13. A console comprising:
a main body; and
a lid disposed on the main body, the lid including a compartment formed therein, wherein the lid is mounted to the main body by a hinge coupled to a rotating element and pivotable relative to the main body about a first axis and about a second axis, and wherein the first axis is disposed at an angle in respect of the second axis.

14. The console according to claim 13, wherein the lid and the rotating element are adapted to receive a wire therein in electrical communication with an input/output device.

15. The console according to claim 13, wherein the compartment is adapted to receive articles for at least one of storage and electronic interface.

16. The console according to claim 13, wherein the compartment is in electrical communication with an input/output device.

17. The console according to claim 13, wherein the rotating element includes a housing, a hollow shaft disposed in the housing, and a bearing element disposed between the housing and the hollow shaft to facilitate a rotation of the shaft therein.

18. The console according to claim 13, wherein the hinge is mounted to the lid and the rotating element is disposed in the main body.

19. The console according to claim 13, wherein the rotating element is disposed in the lid and the hinge is mounted to the main body.

20. The console according to claim 13, wherein the hinge is integrally formed with the rotating element.
